(19) United States
(12) Patent Application Publication
(10) Pub. No.: US 2015/0208129 A1
(43) Pub. Date: Jul. 23, 2015

(54) METHOD AND APPARATUS FOR OPERATING TELEVISION APPLICATION

(71) Applicant: Xiaomi Inc., Beijing (CN)

(72) Inventors: Fa Wang, Beijing (CN); Chuangqi Li, Beijing (CN); Yujie Song, Beijing (CN)

(73) Assignee: Xiaomi Inc.

(21) Appl. No.: 14/524,080

(22) Filed: Oct. 27, 2014

Related U.S. Application Data
(63) Continuation of application No. PCT/CN2014/082936, filed on Jul. 24, 2014.

(30) Foreign Application Priority Data
Jan. 17, 2014 (CN) 201410023710.6

(51) Int. Cl. H04N 21/472; H04N 21/422; H04N 21/482

(52) U.S. Cl. CPC H04N 21/47205; H04N 21/4821; H04N 21/4221

(57) ABSTRACT

A method and a device for operating a television application are provided. The method includes: starting an application editing mode of a television; detecting whether a first icon displayed on a screen of the television is selected; if the first icon is selected, detecting whether a designated key on a remote controller of the television is pressed down; and if the designated key on the remote controller of the television is pressed down, moving the first icon, or adding a first application corresponding to the first icon into a folder.

### CROSS-REFERENCE TO RELATED APPLICATIONS

This application is a continuation of International Application No. PCT/CN2014/082936, filed Jul. 24, 2014, which is based upon and claims priority to Chinese Patent Application No. 201410023710.6, filed Jan. 17, 2014, the entire contents of all of which are incorporated herein by reference.

### TECHNICAL FIELD

The present disclosure generally relates to the field of smart televisions and, more particularly, to methods and apparatuses for operating television applications.

### BACKGROUND

A smart television usually refers to a television that has an operating system and can be installed with application software to realize extended functions. The smart television has a wider range of interactive television platform, may allow users to browse websites through the television and to use various applications, and may integrate functions of computers, digital televisions and Internet to provide diverse multimedia entertainment services.

With the development of smart televisions, the number of applications offered by the televisions increases. Most smart televisions can be controlled with remote controllers. For example, a smart television can be controlled to select an application requested by a user with a remote controller. However, when many applications are installed in the television, the user often needs to press keys for many times to operate an application, and the operation is relatively complex and inconvenient.

### SUMMARY

According to a first aspect of the present disclosure, there is provided a method for operating a television application, comprising: starting an application editing mode of a television; detecting whether a first icon displayed on a screen of the television is selected; if the first icon is selected, detecting whether a designated key on a remote controller of the television is pressed down; and if the designated key on the remote controller of the television is pressed down, moving the first icon, or adding a first application corresponding to the first icon into a folder.

According to a second aspect of the present disclosure, there is provided a device for operating a television application, comprising: a processor; and a memory for storing instructions executable by the processor. The processor is configured to: start an application editing mode of a television; detect whether a first icon displayed on a screen of the television is selected; if the first icon is selected, detect whether a designated key on a remote controller of the television is pressed down; and if the designated key on the remote controller of the television is pressed down, move the first icon, or add a first application corresponding to the first icon into a folder.

According to a third aspect of the present disclosure, there is provided a non-transitory computer-readable storage medium having stored therein instructions that, when executed by a processor of a device, cause the device to perform operations including: starting an application editing mode of a television; detecting whether a first icon displayed on a screen of the television is selected; if the first icon is selected, detecting whether a designated key on a remote controller of the television is pressed down; and if the designated key on the remote controller of the television is pressed down, moving the first icon, or adding a first application corresponding to the first icon into a folder.

It should be understood that, the above general description and the detailed description below are only illustrative but not for limiting the present disclosure.

### BRIEF DESCRIPTION OF THE DRAWINGS

The accompanying drawings, which are incorporated in and constitute a part of this specification, illustrate the embodiments according to the present disclosure, and serve to explain the principles of the present disclosure.

FIG. 1a is a flowchart showing a method for operating a television application, according to an exemplary embodiment.

FIG. 1b is a diagram showing applications displayed on a television screen, according to an exemplary embodiment.

FIG. 1c is a flowchart showing a method for operating a television application, according to an exemplary embodiment.

FIG. 2a is a flowchart showing a method for operating a television application, according to an exemplary embodiment.

FIGS. 2b (1)-(3) are diagrams showing operations of packing television applications into a folder, according to an exemplary embodiment.

FIGS. 2c (1)-(2) are diagrams showing operations of exchanging positions of television applications, according to an exemplary embodiment.

FIG. 3a is a flowchart showing a method for operating a television application, according to an exemplary embodiment.

FIG. 3b is a diagram showing an operation of packing television applications into a folder, according to an exemplary embodiment.

FIG. 3c is a diagram showing operation icons displayed on a television screen in an application editing mode, according to an exemplary embodiment.

FIG. 4a is a flowchart showing a method for operating a television application, according to an exemplary embodiment.

FIG. 4b is a flowchart showing a method for operating a television application, according to an exemplary embodiment.

FIG. 4c is a flowchart showing a method for operating a television application, according to an exemplary embodiment.

FIG. 4d is a flowchart showing a method for operating a television application, according to an exemplary embodiment.

FIG. 4e is a diagram showing various indications displayed after a folder is created, according to an exemplary embodiment.

FIG. 5a is a block diagram of an apparatus for operating a television application, according to an exemplary embodiment.

FIG. 5b is a block diagram of an apparatus for operating a television application, according to an exemplary embodiment.

FIG. 6 is a block diagram of a device, according to an exemplary embodiment.

### DETAILED DESCRIPTION

Reference will now be made in detail to exemplary embodiments, examples of which are illustrated in the accompanying drawings. When accompanying drawings are mentioned in the following description, the same numbers in different drawings represent the same or similar elements, unless otherwise represented. The following exemplary embodiments and description thereof intend to illustrate, rather than to limit, the present disclosure. Hereinafter, the present disclosure will be described with reference to the drawings.

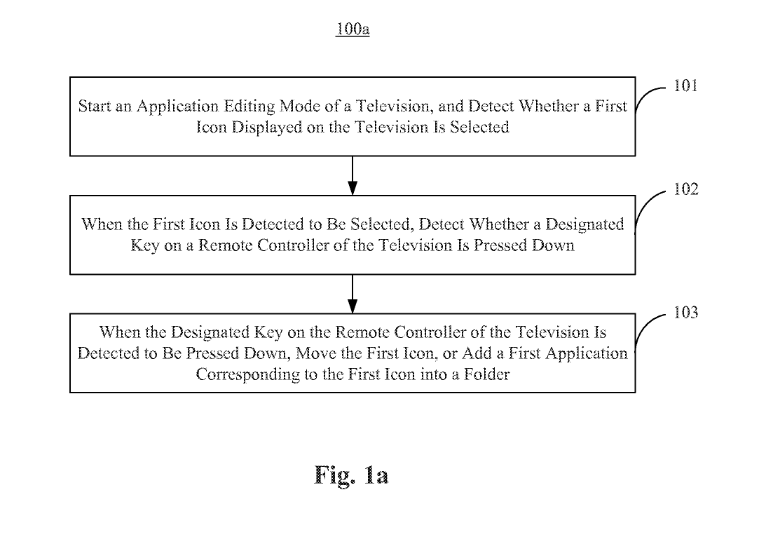

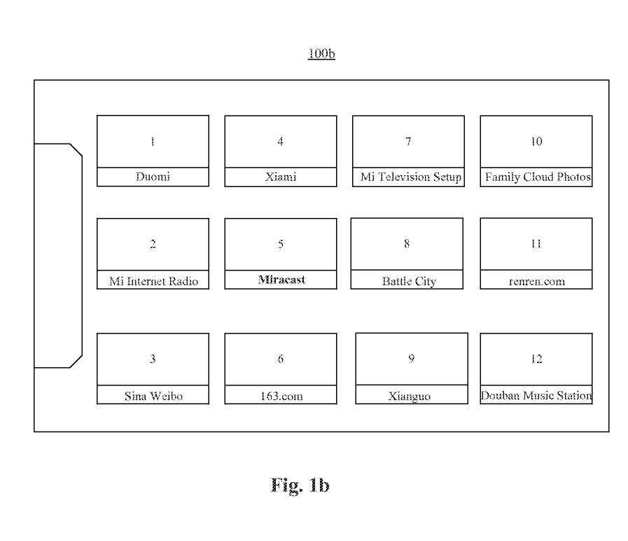

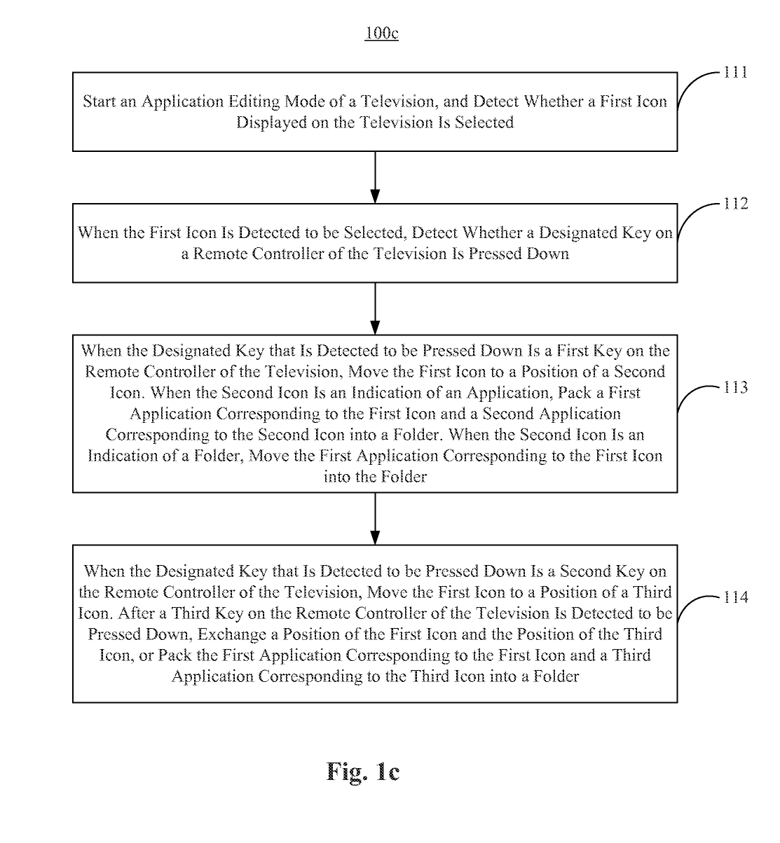

FIG. 1a illustrates a flowchart of an exemplary method 100a for operating a television application, provided by one embodiment of the present disclosure. The method 100a may be performed by various devices, such as a television. The method 100a includes the following steps.

In step 101, the method 100a begins by starting an application editing mode of a television, and detecting whether a first icon displayed on a screen of the television is selected. In some embodiments, a user may start the application editing mode by selecting a menu key on a remote controller of the television. Further, as used in the present disclosure, the screen of the television can be a component of the television, or an external display coupled to the television.

Usually, a plurality of icons are displayed on the screen, and the present embodiment does not limit specific ways by which they are displayed. In one implementation, the icons may be arranged from left to right, and each column contains a designated number of icons, such as two or three and the like. An example diagram 100b showing applications displayed on a television screen is illustrated in FIG. 1b. As shown in FIG. 1b, twelve icons are displayed on the television, three icons are displayed in each column, and the columns are arranged from left to right.

In step 102, when the first icon is detected to be selected, the method 100a proceeds to detect whether a designated key on a remote controller of the television is pressed down.

In step 103, when the designated key on the remote controller of the television is detected to be pressed down, method 100a proceeds to move the first icon or add a first application corresponding to the first icon to a folder.

FIG. 1c illustrates a flowchart of an exemplary method 100c for operating a television application, provided by one embodiment of the present disclosure. The method 100c includes the following steps.

In step 111, the method 100c begins by starting an application editing mode of a television, and detecting whether a first icon displayed on a screen of the television is selected. In some embodiments, a user may start the application editing mode by selecting a menu key on a remote controller of the television.

In step 112, when the first icon is detected to be selected, the method 100c proceeds to detect whether a designated key on a remote controller of the television is pressed down.

In step 113, when the designated key that is detected to be pressed down is a first key on the remote controller of the television, method 100c proceeds to move the first icon to a position of a second icon. The second icon may be located adjacent to the first icon.

In some embodiments, the second icon may be an indication of an application. Accordingly, a first application corresponding to the first icon and a second application corresponding to the second icon may be packed into a folder. For example, when a direction key on the remote controller of the television is detected to be pressed down, the first icon may be moved to the position of the second icon in a direction corresponding to the direction key. Moreover, a folder may be created, and the first application corresponding to the first icon and the second application corresponding to the second icon may be packed into the created folder.

In other embodiments, the second icon may be an indication of a folder. Accordingly, the first application corresponding to the first icon may be moved into the folder.

In step 114, when the designated key that is detected to be pressed down is a second key on the remote controller of the television, the method 100c proceeds to move the first icon to a position of a third icon. The third icon may be located adjacent to the first icon. After a third key on the remote controller of the television is detected to be pressed down, method 100c proceeds to exchange a position of the first icon and the position of the third icon, or pack the first application corresponding to the first icon and a third application corresponding to the third icon into a folder.

In some embodiments, the second key may be a direction key on the remote controller of the television. When the direction key is detected to be pressed down, the first icon may be moved to the position of the adjacent third icon in a direction corresponding to the direction key.

In some embodiments, the third key may be the same as the second key. When the third key identical to the second key is detected to be pressed down, the position of the first icon and the position of the third icon may be exchanged.

In some embodiments, the third key may be a confirmation key. When the third key as a confirmation key is detected to be pressed down, a folder may be created, and the first application corresponding to the first icon and the third application corresponding to the third icon are packed into the folder.

In some embodiments, after the folder is created, the created folder may be displayed in a size occupied by at least two icons. The size occupied by at least two icons is a total size occupied by at least two icons in a single column displayed on the television screen. For example, when three icons are displayed in a single column on the television screen, a height of the folder may be a total height of two or three icons.

In some embodiments, when a folder displayed on the television is selected, a folder deleting indication may be displayed on the television screen. When the folder deleting indication is detected to be selected, the folder may be deleted.

In some embodiments, when a folder displayed on the television is selected, a folder moving indication may be displayed on the television screen. When the folder moving indication is detected to be selected, and a direction key on the remote controller of the television is detected to be pressed down, the folder may be moved in a direction corresponding to the direction key.

In some embodiments, when a folder displayed on the television is selected, a folder entering indication may be displayed on a screen of the television. When the folder entering indication is detected to be selected, icons corresponding to respective applications in the folder may be displayed in a superimposed form. After displaying icons corresponding to respective applications in the folder in a superimposed form of the folder entering indication may be replaced by an application moving indication, and the application moving indication may be displayed on the screen of the television. After an icon in the folder is detected to be selected and the application moving indication is detected to be selected, the selected icon may be moved in a direction corresponding to a direction key on the remote controller of the television that is detected to be pressed down.

In some embodiments, after displaying icons corresponding to respective applications in the folder in a superimposed form, the folder entering indication may be replaced by an application deleting indication, and the application deleting indication may be displayed on the screen of the television. After an icon in the folder is detected to be selected and the application deleting indication is detected to be selected, a dialog box may be popped up to inquire a user whether to perform an operation of deleting an application. An application corresponding to the selected icon may be deleted after a confirmation key on the remote controller of the television is detected to be pressed down. The above described methods 100a and 100c may be applied in a television. The first and second applications described in connection with methods 100a and 100c may each be any one of applications installed in the television. In the above described methods 100a and 100c, operations on the television applications, such as moving or packing into a folder and the like, may be implemented based on a remote controller of a television. In the above described methods 100a and 100c, the key operations are simplified and the number of times for pressing keys is reduced, and thus easiness and flexibility of user operations are improved.

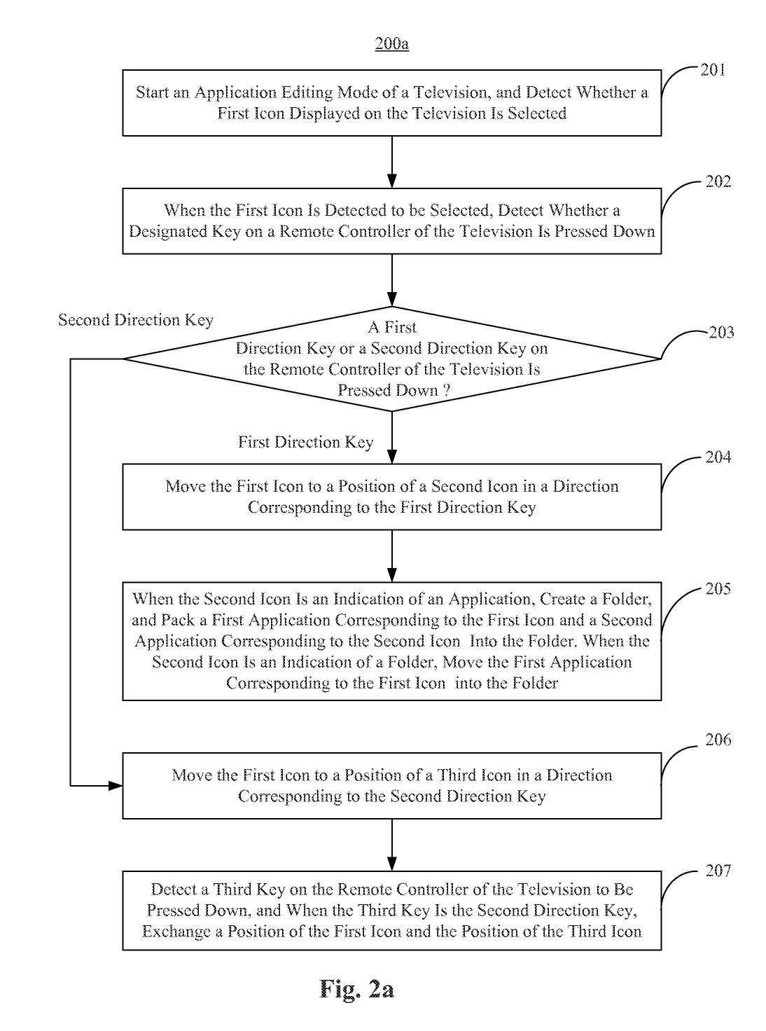

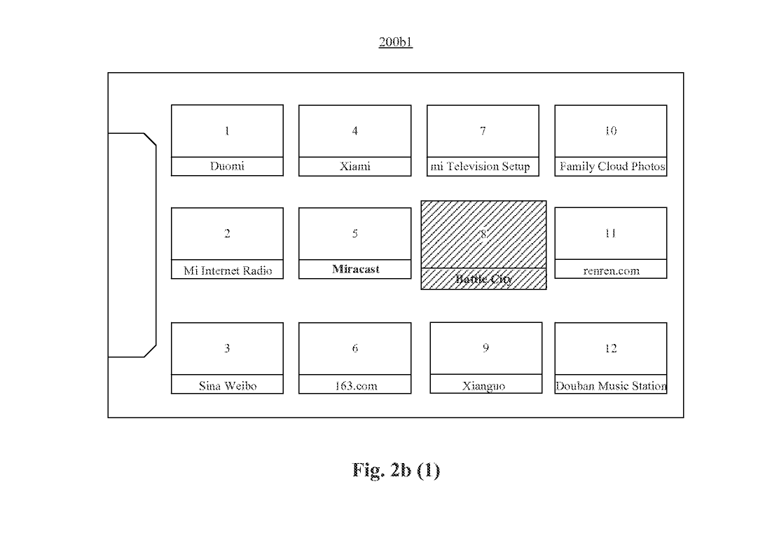

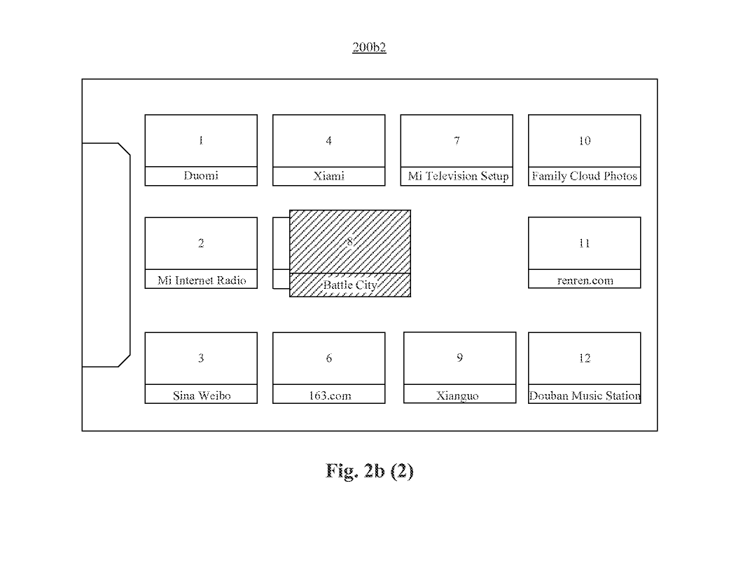

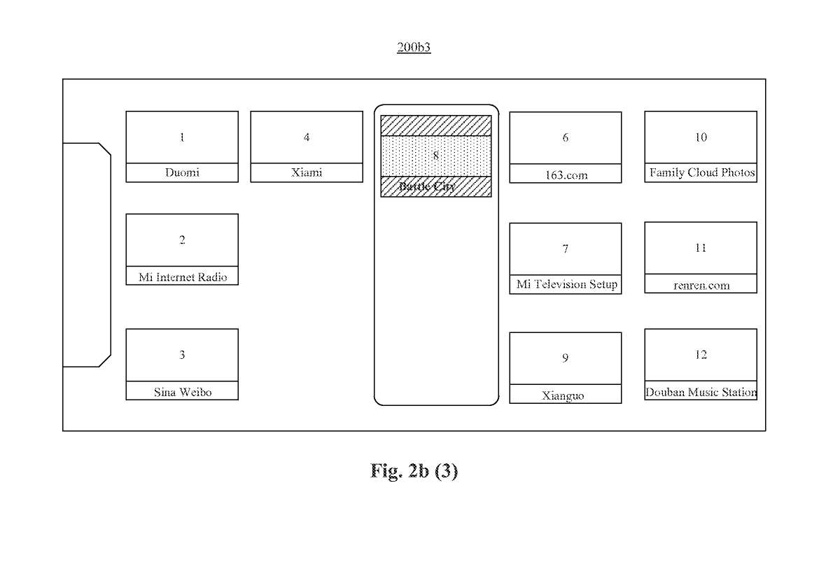

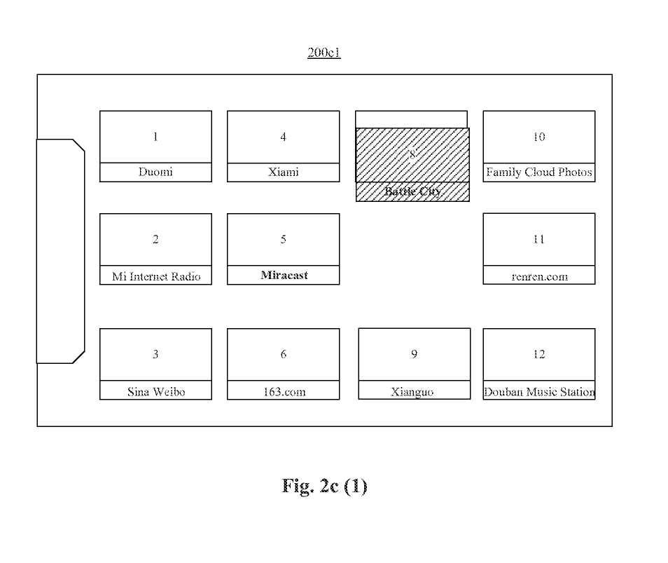

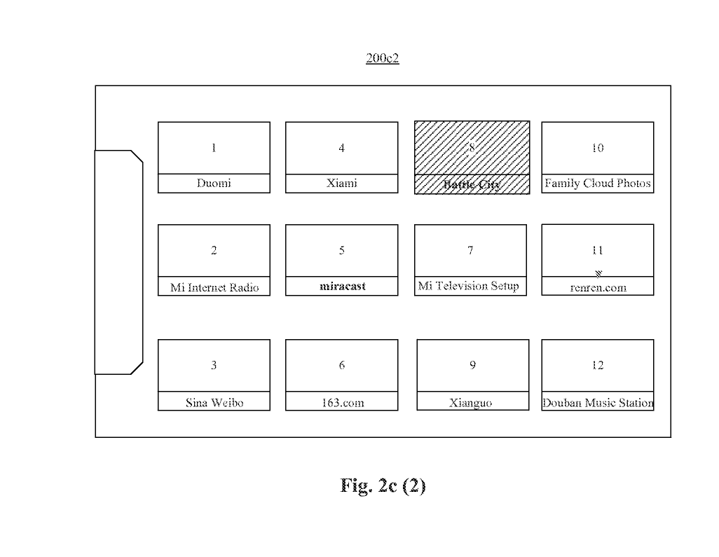

FIG. 2a illustrates a flowchart of an exemplary method 200a for operating a television application, provided by another embodiment of the present disclosure. In the method 200a, applications are controlled to be packed or moved into a folder by a first direction key, and applications are controlled by a second direction key to perform position exchange or to be packed into a folder. The method 200a includes the following steps.

In step 201, the method 200a begins by starting an application editing mode of a television, and detecting whether a first icon displayed on a screen of the television is selected. In some embodiments, a user may start the application editing mode by selecting a menu key on a remote controller of the television.

In step 202, when the first icon is detected to be selected, the method 200a proceeds to detect whether a designated key on a remote controller of the television is pressed down.

In the present embodiment, the first icon corresponds to a first application. The first application may be any one of applications installed in the television.

In step 203, the method 200a proceeds to determine whether the pressed key on the remote controller of the television is a first direction key or a second direction key. If the first direction key is pressed down, step 204 is performed. If the second direction key is pressed down, step 206 is performed.

If the first direction key is detected to be pressed down, in step 204, the method 200a proceeds to move the first icon to a position of a second icon in a direction corresponding to the first direction key. The second icon may be located in an adjacent position to the first icon.

In step 205, when the second icon is an indication of an application, the method 200a proceeds to create a folder, and a first application corresponding to the first icon and a second application corresponding to the second icon are packed into the folder. In some embodiments, after the folder is created, the created folder may be displayed in a size occupied by at least two icons. When the second icon is an indication of a folder, the method 200a proceeds to move the first application corresponding to the first icon into the folder. A folder may include two or more applications, for example, it may include six to eight applications.

In some embodiments, the first direction key may be a left key or a right key, and the first application may be controlled to be packed into the folder together with a second application on a left side or on a right side. Example diagrams 200b1, 200b2, and 200b3, showing operations of packing television applications into a folder through a left key are illustrated in FIGS. 2b (1)-(3), respectively. As shown in FIG. 2b (1), an application 8 is detected to be selected and then is displayed as highlighted. After an application moving icon (not shown) displayed on the television screen is selected, a left key on the remote controller of the television is detected to be pressed down, the application 8 is then moved left to a position of an adjacent application 5 on the left side, as shown in FIG. 2b (2). A folder is created, and the application 8 and the application 5 are packed into the folder. As shown in FIG. 2b (3), a height of the folder is a total height of the whole column, and the folder is placed next to an application 4. It should be understood that although a left key is used in this example, any other direction key may be used without departing from the spirit of the present disclosure.

Referring back to FIG. 2a, if a second direction key is detected to be pressed down, in step 206, the method 200a proceeds to move the first icon to a position of a third icon in a direction corresponding to the second direction key. The third icon may be located in a position adjacent to the first icon.

In step 207, a third key on the remote controller of the television is detected to be pressed down, and when the third key is the second direction key, the method 200a proceeds to exchange a position of the first icon and the position of the third icon.

Example diagrams 200c1 and 200c2 showing operations of exchanging positions of television applications through an up key are illustrated in FIGS. 2c (1)-(2), respectively. In FIG. 2c (1), the application 8 is detected to be selected. After an application moving icon (not shown) displayed on the television screen is selected, an up key on the remote controller of the television is detected to be pressed down, and then the application 8 is moved upward to a position of an application 7 as shown in FIG. 2c (1). At this time, the two applications are displayed in a superimposed state. In FIG. 2c (2), the up key on the remote controller of the television is detected to be pressed down once again, and then the positions of the application 8 and the application 7 are exchanged as shown in FIG. 2c (2). At this time, the application 8 is displayed above the application 7. It should be understood that although an up key is used in this example, any other direction key may be used without departing from the spirit of the present disclosure.

The above described method 200a may be applied in a television.

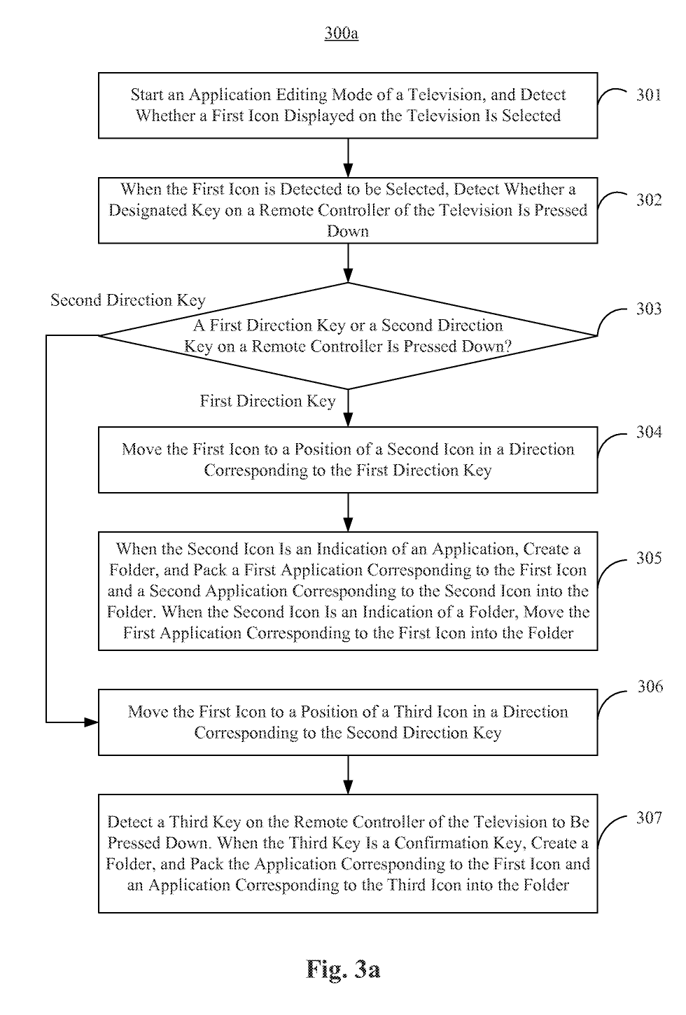

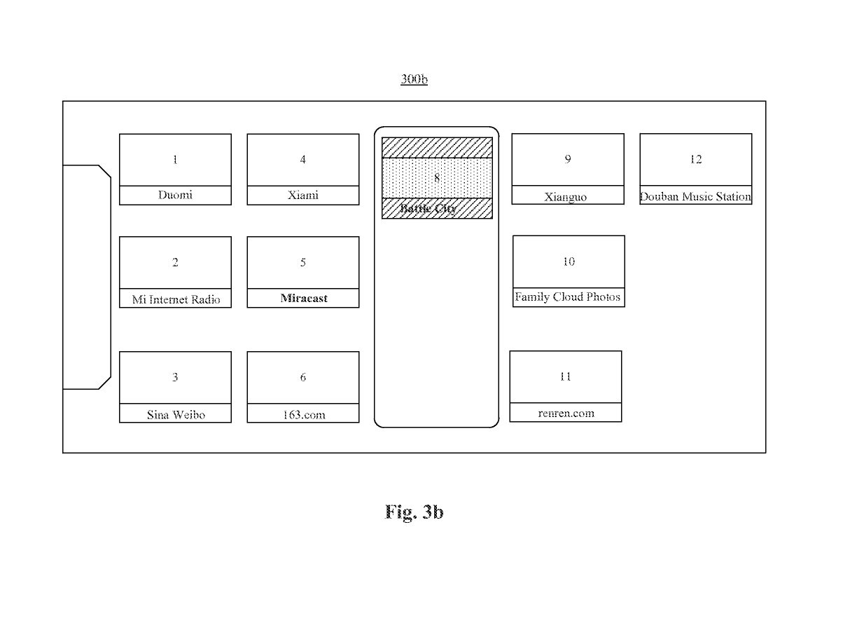

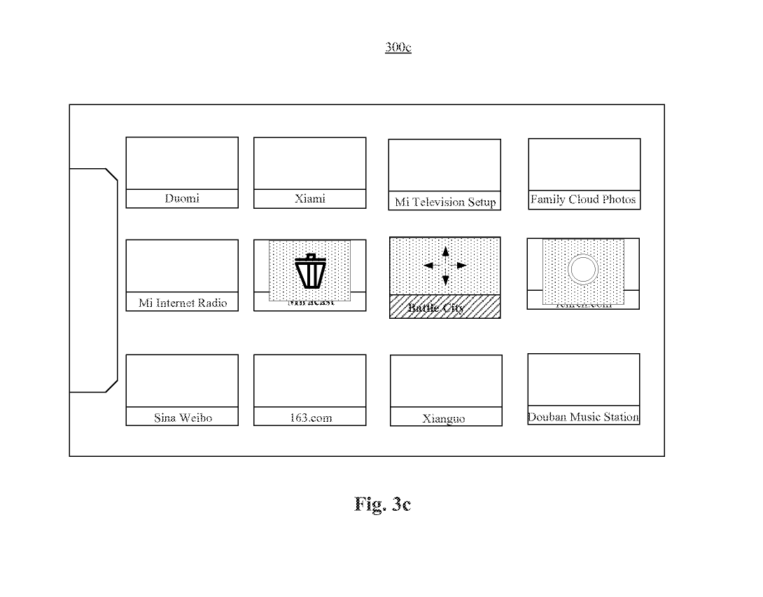

In the above described method 200a, operations on the television applications, such as moving or packing into a folder and the like, may be implemented based on a remote controller of a television. The key operations are simplified and the number of times for pressing keys is reduced, and thus easiness and flexibility of operations are improved. FIG. 3a illustrates a flowchart of an exemplary method 300a for operating a television application, provided by another embodiment of the present disclosure. In the method 300a, an application may be controlled to be packed into a folder through a second direction key in combination with a confirmation key. The method 300a includes the following steps.

In step 301, the method 300a begins by starting an application editing mode of a television, and detecting whether a first icon displayed on the television is selected. In some embodiments, a user may start the application editing mode by selecting a menu key on a remote controller of the television.

In step 302, when the first icon is detected to be selected, the method 300a proceeds to detect whether a designated key on a remote controller of the television is pressed down.

In step 303, the method 300a proceeds to determine whether the pressed key on the remote controller of the television is a first direction key or a second direction key. If the first direction key is detected to be pressed down, step 304 is performed. If the second direction key is detected to be pressed down, step 306 is performed.

If the first direction key is detected to be pressed down, in step 304, the method 300a proceeds to move the first icon to a position of a second icon in a direction corresponding to the first direction key. The second icon may be located in a position adjacent to the first icon.

In step 305, when the second icon is an indication of an application, the method 300a proceeds to create a folder, and pack a first application corresponding to the first icon and a second application corresponding to the second icon into the folder. When the second icon is an indication of a folder, the method 300a proceeds to move the first application corresponding to the first icon into the folder.

If the second direction key is detected to be pressed down, in step 306, the method 300a proceeds to move the first icon to a position of a third icon in a direction corresponding to the second direction key. The third icon may be located in a position adjacent to the first icon.

In step 307, a third key on the remote controller of the television is detected to be pressed down. When the third key is a confirmation key, the method 300a proceeds to create a folder, and pack the application corresponding to the first icon and an application corresponding to the third icon into the folder.

The method 300a differs from method 200a in that the third key is not a direction key but a confirmation key. In method 300a, the first application and the adjacent application in a second direction (such as on an upper side or a down side) may be controlled to be packed into a folder.

An example diagram 300b showing an operation of packing television applications into a folder through an up key and a confirmation key is illustrated in FIG. 3b. Referring to FIG. 2c (1), an application 8 is detected to be selected. After an application moving icon (not shown) displayed on the television screen is selected, an up key on the remote controller of the television is detected to be pressed down. The application 8 is then moved upward to the position of the application 7 and is displayed as superimposed on the application 7 as shown in FIG. 2c (1). Then, a confirmation key on the remote controller of the television is detected to be pressed down, a folder is created, and the application 8 and the application 7 are packed into the folder, where the folder is placed next to an application 6, as shown in FIG. 3b. Applications 9-12 are respectively moved to corresponding positions. It should be understood that although an up key is used in this example, any other direction key may be used without departing from the spirit of the present disclosure.

In some embodiments, after the folder is created, the created folder may be displayed in a size occupied by at least two icons.

An example diagram 300c showing operation icons displayed on a television screen in an application editing mode is illustrated in FIG. 3c. As shown in FIG. 3c, in the application editing mode, if the application 8 is selected, three operational types of icons are displayed on the television screen, including an application deleting icon, an application moving icon and an application entering icon, respectively, from left to right. Accordingly, an application deleting operation, an application moving operation, and an application entering operation may be performed by a user selecting one of these operation icons.

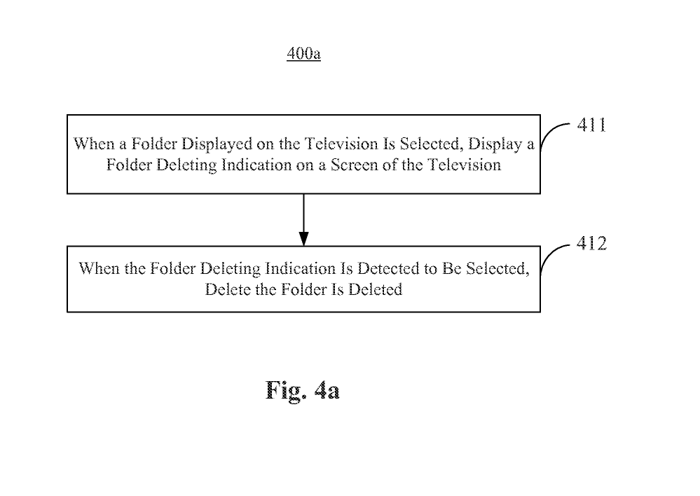

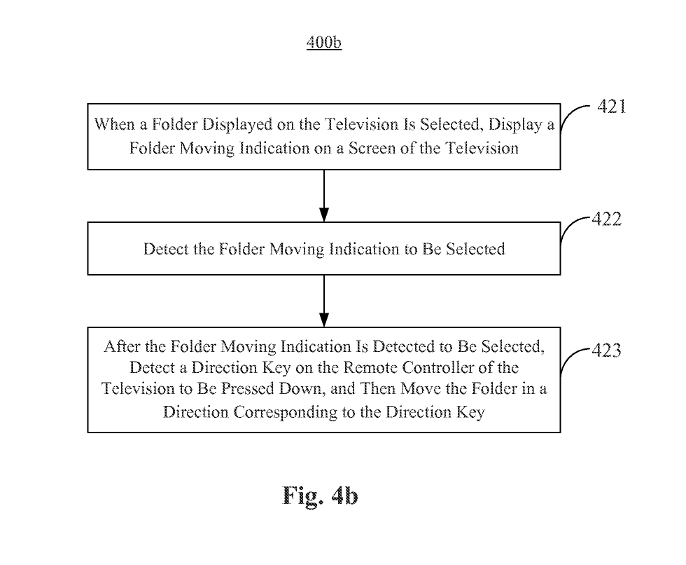

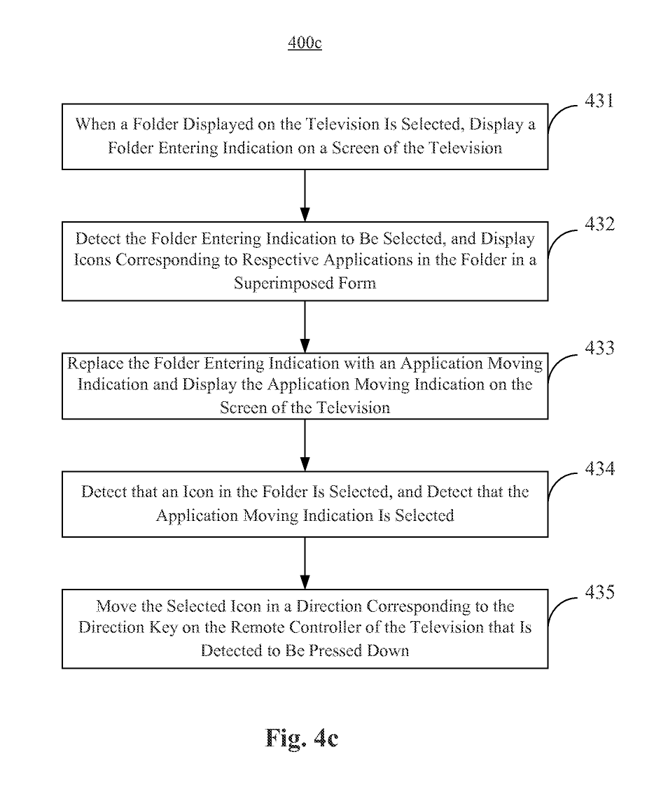

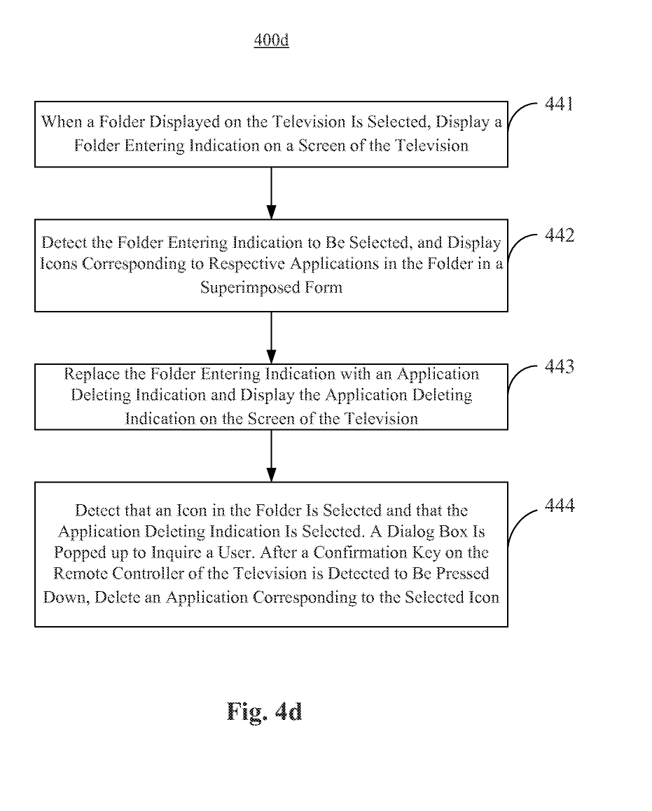

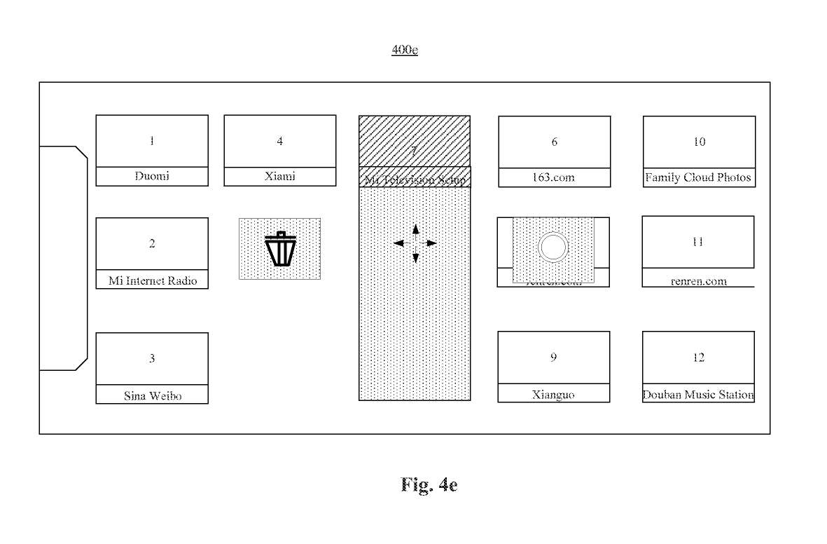

The above described method 300a may be applied in a television. In the above described method 300a, operations on the television applications, such as moving or packing into a folder and the like, may be implemented based on a remote controller of a television. The key operations are simplified and the number of times for pressing keys is reduced, and thus easiness and flexibility of operations are improved. FIG. 4a illustrates a flowchart of an exemplary method 400a provided by another embodiment of the present disclosure. In the method 400a, a deleting operation may be performed on the created folder. The method 400a includes the following steps.

In step 411, when a folder displayed on the television is selected, the method 400a begins by displaying a folder deleting indication on a screen of the television.

The folder deleting indication may be a folder deleting icon, and the present embodiment does not impose specific limitations on this.

In step 412, when the folder deleting indication is detected to be selected, the method 400a proceeds to delete the folder.

In the method 400a, a folder deleting operation may be performed by selecting a folder deleting indication. Thus, the operation is simple and it is convenient for a user to operate.

FIG. 4b illustrates a flowchart of an exemplary method 400b provided by another embodiment of the present disclosure. In the method 400b, a moving operation may be performed on the created folder. The method 400b includes the following steps.

In step 421, when a folder displayed on the television is selected, the method 400b begins by displaying a folder moving indication on a screen of the television.

The folder moving indication may be a folder moving icon, and the present embodiment does not impose specific limitations on this.

In step 422, the method 400b proceeds to detect that the folder moving indication is selected.

In step 423, after the folder moving indication is detected to be selected, the method 400b proceeds to detect that a direction key on the remote controller of the television is pressed down, and then move the folder in a direction corresponding to the direction key.

In the above described method 400b, the folder may be controlled to be moved in any direction through a direction key. Thus, the operation is simple and it is convenient for a user to operate.

FIG. 4c illustrates a flowchart of an exemplary method 400c provided by another embodiment of the present disclosure. In the method 400c, a moving operation may be performed on applications in a folder. The method 400c includes the following steps.

In step 431, when a folder displayed on the television is selected, the method 400c begins by displaying a folder entering indication on a screen of the television.

The folder entering indication may be a folder entering icon, and the present embodiment does not impose specific limitations on this.

In step 432, the method 400c proceeds to detect that the folder entering indication is selected, and display icons corresponding to respective applications in the folder in a superimposed form.

In step 433, the method 400c proceeds to replace the folder entering indication with an application moving indication, and display the application moving indication on the screen of the television.

In step 434, the method 400c proceeds to detect that an icon in the folder is selected, and detect that the application moving indication is selected.

In step 435, method 400c proceeds to move the selected icon in a direction corresponding to the direction key on the remote controller of the television that is detected to be pressed down. For example, a left key or a right key on the remote controller of the television may be detected to be pressed down, and the selected icon may be moved to the left or to the right side out of the folder correspondingly; In another example, an up key or a down key on the remote controller of the television may be detected to be pressed down, and the selected icon may be moved up or moved down within the folder correspondingly.

In the method 400c, after a user selects an application in a folder, an operation of moving the selected application out of the folder may be implemented through the left key or the right key, and an operation of moving the application within the folder may be implemented through the up key or the down key. Thus, the operation is simple and it is convenient for a user to operate.

FIG. 4d illustrates a flowchart of an exemplary method 400d provided by another embodiment of the present disclosure. In the method 400d, a deleting operation may be performed on applications in a folder. The method 400d includes the following steps.

In step 441, when a folder displayed on the television is selected, the method 400d begins by displaying a folder entering indication on a screen of the television.

The folder entering indication may be a folder entering icon, and the present embodiment does not impose specific limitations on this.

In step 442, the method 400d proceeds to detect that the folder entering indication is selected, and display icons corresponding to respective applications in the folder in a superimposed form.

In step 443, the method 400d proceeds to replace the folder entering indication with an application deleting indication, and display the application deleting indication on the screen of the television.

In step 444, the method 400d proceeds to detect that an icon in the folder is selected and detect that the application deleting indication is selected. A dialog box may be popped up to inquire a user whether to perform an operation of deleting an application. After a confirmation key on the remote controller of the television is detected to be pressed down, the method 400d proceeds to delete an application corresponding to the selected icon.

In the method 400d, after a user selects an application in a folder, deleting the application in the folder may be implemented by selecting the application deleting indication. Thus, the operation is simple and it is convenient for a user to operate.

An example diagram 400e showing various indications displayed on the television screen after a folder is created is illustrated in FIG. 4e. As shown in FIG. 4e, a folder entering indication, a folder moving indication, and a folder deleting indication are displayed on the television screen after a folder is created. There are a total of twelve applications on the television screen, including applications 1-12, and the applications 7 and 5 are packed into one folder. When the folder is selected, a folder moving indication is displayed on the folder, a folder deleting indication is displayed on the left side of the folder, and a folder entering indication is displayed on the right side of the folder. Thus, a user may select a desired indication and thereby perform a corresponding operation.

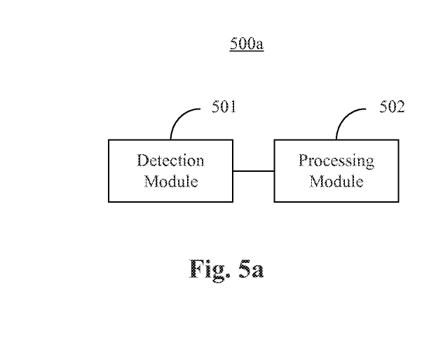

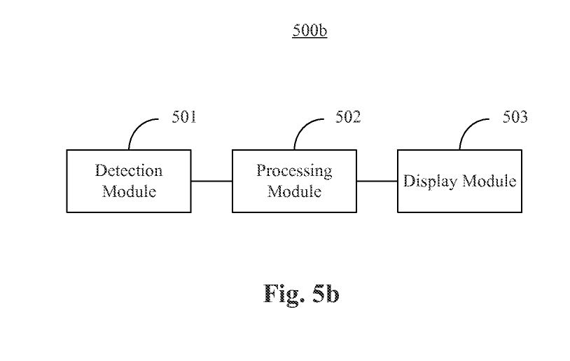

FIG. 5a illustrates an exemplary block diagram of an apparatus 500a for operating a television application. The apparatus 500a includes a detection module 501 and a processing module 502.

The detection module 501 may be configured to start an application editing mode of a television, and to detect whether a first icon displayed on the television is selected. When the first icon is selected, the detection module 501 may further be configured to detect whether a designated key on a remote controller of the television is pressed down.

The processing module 502 may be configured to, when the designated key on the remote controller of the television is pressed down, move the first icon, or add a first application corresponding to the first icon to a folder.

The processing module 502 may include a number of sub modules. For example, the processing module 502 may include a first processing sub module and a second processing sub module.

The first processing sub module may be configured to, when a designated first key on the remote controller of the television is pressed down, move the first icon to a position of a second icon. The second icon may be located in a position adjacent to the first icon. When the second icon is an indication of an application, the first processing sub module may be configured to pack the first application corresponding to the first icon and a second application corresponding to the second icon into a folder. When the second icon is an indication of a folder, the first processing sub module may be configured to move the first application corresponding to the first icon into the folder.

The second processing sub module may be configured to, when a designated second key on the remote controller of the television is pressed down, move the first icon to a position of a third icon. The third icon may be located in a position adjacent to the first icon. After a designated third key on the remote controller of the television is detected to be pressed down, the second processing sub module may be configured to exchange a position of the first icon and the position of the third icon or pack the first application corresponding to the first icon and a third application corresponding to the third icon into a folder.

In some embodiments, the first processing sub module may include a first packing unit. The first packing unit may be configured to, when a designated first direction key on the remote controller of the television is pressed down, move the first icon to the position of the second icon in a direction corresponding to the first direction key, create a folder, and pack the first application corresponding to the first icon and the second application corresponding to the second icon into the folder. The second icon may be located in a position adjacent to the first icon.

In some embodiments, the second processing sub module may include a first moving unit. The first moving unit may be configured to, when a designated second direction key on the remote controller of the television is pressed down, move the first icon to the position of the adjacent third icon in a direction corresponding to the second direction key.

The second processing sub module may also include an exchange unit and a second packing unit.

The exchange unit may be configured to, when the third key is the second direction key, exchange the position of the first icon and the position of the third icon. The second packing unit may be configured to, when the third key is a confirmation key, create a folder, and pack the first application corresponding to the first icon and the third application corresponding to the third icon into the folder.

FIG. 5b illustrates an exemplary block diagram of another apparatus 500b for operating a television application. In addition to the detection module 501 and processing module 502, the apparatus 500b may further include a display module 503. The display module 503 may be configured to, after the folder is created, display the created folder in a size occupied by at least two icons. The display module 503 may be further configured to, when a folder displayed on the television is selected, display a folder deleting indication on a screen of the television.

In addition to a first and second processing sub modules discussed above, the processing module may further include a third processing sub module. The third processing sub module may be configured to, when the folder deleting indication is detected to be selected, delete the folder. The display module may be further configured to, when a folder displayed on the television is selected, display a folder moving indication on a screen of the television.

The processing module may further include a fourth processing sub module. The fourth processing sub module may be configured to, when the folder moving indication is detected to be selected and a direction key on the remote controller of the television is detected to be pressed down, move the folder in a direction corresponding to the direction key. The display module may be further configured to, when a folder displayed on the television is selected, display a folder entering indication on a screen of the television.

The processing module may further include a fifth processing sub module configured to detect that the folder entering indication is selected. The display module may be further configured to display icons corresponding to respective applications in the folder as compressed in a superimposed form. The display module may be further configured to, replace the folder entering indication with an application moving indication and display the application moving indication on a screen of the television.

The fifth processing sub module may include a second moving unit. The second moving unit may be configured to, after an icon in the folder is detected to be selected and the application moving indication is detected to be selected, move the selected icon in a direction corresponding to a direction key on the remote controller of the television that is detected to be pressed down. The display module may be further configured to replace the folder entering indication with an application deleting indication, and display the application deleting indication on a screen of the television.

The fifth processing sub module may also include a deleting unit. The deleting unit may be configured to, after an icon in the folder is detected to be selected and the application deleting indication is detected to be selected, pop up a dialog box to inquire a user whether to perform an operation of deleting an application, and delete an application corresponding to the selected icon after a confirmation key on the remote controller of the television is detected to be pressed down.

The above described apparatuses 500a and 500b may be implemented in a television.

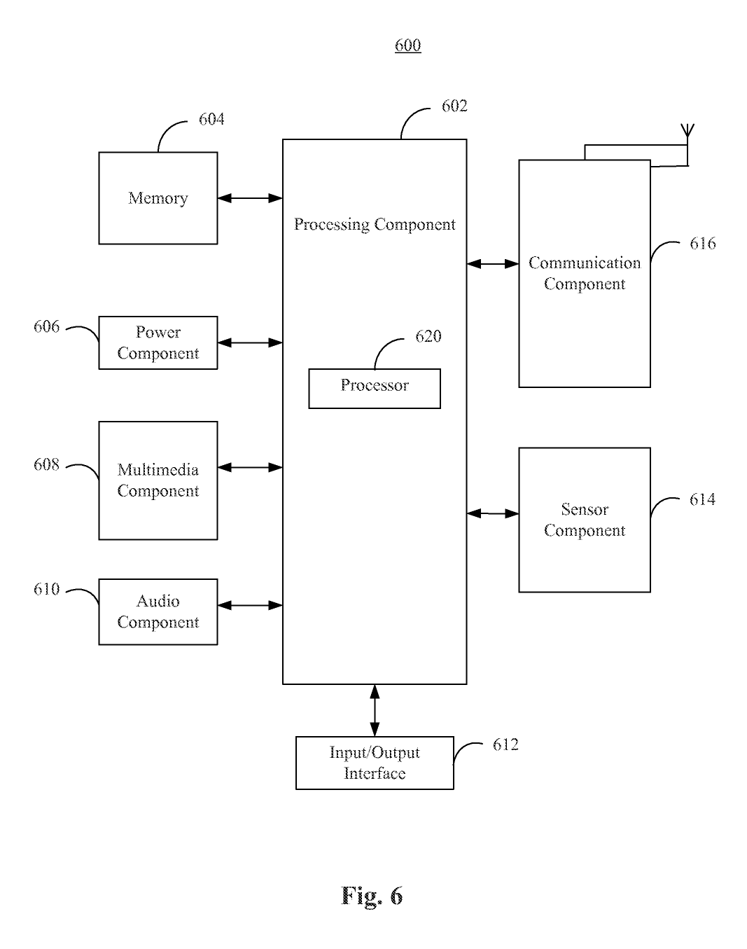

FIG. 6 illustrates an exemplary block diagram of a device 600 for operating a television application, according to an exemplary embodiment. For example, the device 600 may be a smart television.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616. The person skilled in the art should appreciate that the structure of the device 600 as shown in FIG. 6 does not intend to limit the device 600. The device 600 may include more or less components or combine some components or other different components.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 is also configured to store programs and modules. The processing component 602 performs various functions and data processing by operating programs and modules stored in the memory 604. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 is configured to provide power to various components of the device 600. The power component 606 may include a power management system, one or more power sources, and/or any other components associated with the generation, management, and distribution of power in the device 600.

The multimedia component 608 includes a screen providing an output interface between the device 600 and the user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures performed on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 may include a microphone (“MIC”) configured to receive an external audio signal when the device 600 is in an operation mode, such as a call mode, a recording mode, and/or a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and/or a locking button.

The sensor component 614 includes one or more sensors to provide status assessments of various aspects of the device 600. For instance, the sensor component 614 may detect an on/off status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and/or a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G, or 3G, or a combination thereof. In one exemplary embodiment, the communication component 616 receives a broadcast signal or information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and/or other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described methods, apparatuses, and modules can each be implemented through hardware, or software, a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for operating a television application, comprising:
starting an application editing mode of a television;
detecting whether a first icon displayed on a screen of the television is selected;
if the first icon is selected, detecting whether a designated key on a remote controller of the television is pressed down; and
if the designated key on the remote controller of the television is pressed down, moving the first icon, or adding a first application corresponding to the first icon into a folder.

2. The method of claim 1, further comprising:
determining that the designated key is a first key on the remote controller of the television;
in response to the determining, moving the first icon to a position of a second icon; and
packing the first application corresponding to the first icon and a second application corresponding to the second icon into the folder, when the second icon is an indication of an application.

3. The method of claim 2, wherein:
the first key is a direction key; and
the first icon is moved to the position of the second icon in a direction corresponding to the direction key.

4. The method of claim 2, further comprising:
creating the folder prior to packing the first application corresponding to the first icon and the second application corresponding to the second icon into the folder.

5. The method of claim 1, further comprising:
determining that the designated key is a first key on the remote controller of the television;
in response to the determining, moving the first icon to a position of a second icon; and
moving the first application corresponding to the first icon into the folder, when the second icon is an indication of the folder.

6. The method of claim 1, further comprising:
determining that the designated key is a second key on the remote controller of the television;
in response to the determining, moving the first icon to a position of a third icon;
detecting whether a third key on the remote controller of the television is pressed down;
in response to detecting that the third key on the remote controller of the television is pressed down, exchanging a position of the first icon and the position of the third icon or packing the first application corresponding to the first icon and a third application corresponding to the third icon into the folder.

7. The method of claim 6, wherein:
the second key is a direction key on the remote controller of the television; and
the first icon is moved to the position of the third icon in a direction corresponding to the direction key.

8. The method of claim 7, wherein:
the third key is the direction key; and
the position of the first icon and the position of the third icon are exchanged.

9. The method of claim 7, wherein:
the third key is a confirmation key; and
the first application corresponding to the first icon and the third application corresponding to the third icon are packed into the folder.

10. The method of claim 9, further comprising:
creating the folder prior to packing the first application corresponding to the first icon and the third application corresponding to the third icon into the folder; and
displaying the folder in a size occupied by at least two icons.

11. The method of claim 9, further comprising:
when the folder is selected, displaying at least one of a folder deleting indication, a folder moving indication, or a folder entering indication on a screen of the television.

12. The method of claim 11, further comprising:
detecting that the folder entering indication is selected;
replacing the displayed folder entering indication with an application moving indication;
detecting that a fourth icon in the folder is selected;
detecting that the application moving indication is selected;
detecting that a direction key on the remote controller of the television is pressed down; and
moving the fourth icon in a direction corresponding to the direction key on the remote controller of the television.

13. The method of claim 11, further comprising:
detecting that the folder entering indication is selected;
replacing the displayed folder entering indication with an application deleting indication;
detecting that a fourth icon in the folder is selected;
detecting that the application deleting indication is selected;
displaying a dialog box to inquire a user whether to perform an operation of deleting an application;
detecting that a confirmation key on the remote controller of the television is pressed down; and
deleting an application corresponding to the fourth icon.

14. A device for operating a television application, comprising:
a processor; and
a memory for storing instructions executable by the processor, wherein the processor is configured to:
start an application editing mode of a television;
detect whether a first icon displayed on a screen of the television is selected;
if the first icon is selected, detect whether a designated key on a remote controller of the television is pressed down; and
if the designated key on the remote controller of the television is pressed down, move the first icon, or add a first application corresponding to the first icon into a folder.

15. The device according to claim 14, wherein the processor is further configured to:
determine that the designated key is a first key on the remote controller of the television;
in response to the determining, move the first icon to a position of a second icon; and
pack the first application corresponding to the first icon and a second application corresponding to the second icon into the folder, when the second icon is an indication of an application.

16. The device according to claim 15, wherein the processor is further configured to:
create the folder prior to packing the first application corresponding to the first icon and the second application corresponding to the second icon into the folder.

17. The device according to claim 14, wherein the processor is further configured to:
determine that the designated key is a first key on the remote controller of the television; and
in response to the determining, moving the first icon to a position of a second icon; and
move the first application corresponding to the first icon into the folder, when the second icon is an indication of the folder.

18. The device according to claim 14, wherein the processor is further configured to:
determine that the designated key is a second key on the remote controller of the television is pressed down;
in response to the determining, move the first icon to a position of a third icon;
detect whether a third key on the remote controller of the television is pressed down;
in response to detecting that the third key on the remote controller of the television is pressed down, exchange a position of the first icon and the position of the third icon or pack the first application corresponding to the first icon and a third application corresponding to the third icon into the folder.

19. The device according to claim 18, wherein:
the second key is a direction key on the remote controller; and
the first icon is moved to the position of the third icon in a direction corresponding to the direction key.

20. The device according to 19, wherein:
the third key is the direction key; and
the position of the first icon and the position of the third icon are exchanged.

21. The device according to claim 19, wherein:
the third key is a confirmation key; and
the first application corresponding to the first icon and the third application corresponding to the third icon are packed into the folder.

22. The device according to claim 21, wherein the processor is further configured to:
create the folder prior to packing the first application corresponding to the first icon and the third application corresponding to the third icon into the folder; and
display the folder in a size occupied by at least two icons.

23. The device according to claim 21, wherein the processor is further configured to:
when the folder is selected, display at least one of a folder deleting indication, a folder moving indication, or a folder entering indication on a screen of the television.

24. The device according to claim 23, wherein the processor is further configured to:
detect that the folder entering indication is selected;
replace the displayed folder entering indication with an application moving indication;
detect that a fourth icon in the folder is selected;
detect that the application moving indication is selected;
detect that a direction key on the remote controller of the television is pressed down; and
move the fourth icon in a direction corresponding to the direction key on the remote controller of the television.

25. The device according to claim 23, wherein the processor is further configured to:
detect that the folder entering indication is selected;
replace the displayed folder entering indication with an application deleting indication;
detect that a fourth icon in the folder is selected;
detect that the application deleting indication is selected;
display a dialog box to inquire a user whether to perform an operation of deleting an application;
detect that a confirmation key on the remote controller of the television is pressed down; and
delete an application corresponding to the fourth icon.

26. A non-transitory computer-readable storage medium having stored therein instructions that, when executed by a processor of a device, cause the device to perform operations including:
starting an application editing mode of a television;
detecting whether a first icon displayed on a screen of the television is selected;
if the first icon is selected, detecting whether a designated key on a remote controller of the television is pressed down; and
if the designated key on the remote controller of the television is pressed down, moving the first icon, or adding a first application corresponding to the first icon into a folder.
